(19) United States
(12) Patent Application Publication
(10) Pub. No.: US 2024/0038062 A1
(43) Pub. Date: Feb. 1, 2024

(54) INFORMATION PROVISION APPARATUS, INFORMATION PROVISION METHOD, AND PROGRAM

(71) Applicant: NEC Corporation, Minato-ku, Tokyo (JP)

(72) Inventors: Tetsuro HASEGAWA, Tokyo (JP); Takayuki SASAKI, Tokyo (JP); Hiroaki AMINAKA, Tokyo (JP); Kazuki OGATA, Tokyo (JP); Kei YANAGISAWA, Tokyo (JP); Kosei KOBAYASHI, Tokyo (JP)

(73) Assignee: NEC Corporation, Minato-ku, Tokyo (JP)

(21) Appl. No.: 18/021,479

(22) PCT Filed: Aug. 25, 2020
(86) PCT No.: PCT/JP2020/032044

§ 371 Date: Feb. 15, 2023

(51) Int. Cl. G08G 1/01; G06V 20/54

(52) U.S. Cl. CPC G08G 1/0141; G08G 1/0133; G08G 1/0116; G06V 20/54; G06V 2201/08

(57) ABSTRACT

An information provision apparatus includes: a data acquisition part that acquires data from a sensor(s) installed to grasp movement of a vehicle(s) traveling on a road; a database that accumulates primary data acquired by the sensor(s); a user-specific processing content storage part that stores a user-specific processing content(s) defining a processing content(s) on the primary data for each data user; a data processing part that reads out the user-specific processing content(s) stored in the user-specific processing content storage part and creates secondary data for the data user(s) from the primary data; and a data transmission part that transmits the secondary data to the data user(s).

### TECHNICAL FIELD

The present invention relates to an information provision apparatus, an information provision method, and a program.

### BACKGROUND ART

Patent Literature (PTL) 1 discloses a road information display apparatus capable of obtaining high value-added road information by predicting changes in traffic congestion conditions or the like and reducing a travel-time calculation error caused by the changes in traffic congestion conditions or the like. According to PTL 1, this road information collection system internally processes road information collected by various sensors on roads and distributes processed data to a road information display system and a road information analysis system. Furthermore, the road information analysis system accumulates the data distributed from the road information collection system in a data storage apparatus, creates predicted data using a neural network method based on the distributed data and the data accumulated in the data storage apparatus, and distributes the predicted data to the road information display system. Next, the road information display system calculates current and future road conditions, travel time, etc. from the data distributed from the road information collection system and the predicted data distributed from the road information analysis system and displays/broadcasts the calculated results through various display/broadcast facilities on the roads.

PTL 2 discloses a vehicle-related information provision system capable of improving the usability of data obtained by a vehicle-mounted apparatus. Concretely, PTL 2 discloses a vehicle-related information provision system including a vehicle-mounted apparatus mounted in a vehicle, a server apparatus capable of mutually communicating with the vehicle-mounted apparatus via a communication line, and a user terminal capable of mutually communicating with the server apparatus via a communication line. The server apparatus has a raw data database for storing data transmitted from the vehicle-mounted apparatus, means for processing the data transmitted from the vehicle-mounted apparatus, and a processed data database for storing the processed data. Further, the server apparatus includes means for searching the processed data database for data of vehicle-related information corresponding to user identification information transmitted from the user terminal. The server apparatus also includes means for acquiring a list of display items of the vehicle-related information usable by the user or data of the vehicle-related information and means for transmitting the acquired data to the user terminal.

### CITATION LIST

### Patent Literature

PTL 1: Japanese Patent Kokai Publication No. JPH06-348992
PTL 2: Japanese Patent Kokai Publication No. JP2004-021331

### SUMMARY

### Technical Problem

The following analysis has been provided by the present inventors. As disclosed in PTL 1, various sensors are disposed on roads and data such as the number, speed, density, and so on of vehicles traveling on the roads can be collected. Further, in recent years, a vehicle-to-road communication system has been proposed as one of the functions of an ADAS (Advanced Driver Assistance System). Regarding the vehicle-to-road communication system, there has been studied to install camera-equipped roadside apparatuses at intersections with poor visibility and to assist other vehicle's drivers in safe driving by using camera images.

By aggregating the information obtained by an individual sensor as described above, e.g., the number of vehicles traveling on a road, the number of vehicles that have passed through a certain location in one month or one year can be obtained, and such information in itself is considered to be valuable as data. In addition, by concurrently using the corresponding camera images, information indicating the types of vehicles that have passed can also be obtained, but they are currently discarded after a certain period of time because they are associated with personal information.

In this regard, in PTL 1, these data are inputted to the road information analysis system configured to predict information about the road in a predetermined period of time by using a neural network and used only to predict the information about the road in the predetermined time.

PTL 2 discloses to collect and process data (raw data) transmitted from a vehicle-mounted apparatus. However, the “processing” discussed in PTL 2 is limited to processing for collecting driving record data, which is referred to as the raw data, per vehicle and creating vehicle-operation management information, traffic management information, congestion management information, store arrival management information, and the like.

An object of the present invention is to provide an information provision apparatus, an information provision method, and a program that can contribute to utilization of information obtained by various sensors installed on a road or the like, as described above.

### Solution to Problem

According to a first aspect, there is provided an information provision apparatus, including: a data acquisition part that acquires data from a sensor(s) installed to grasp movement of a vehicle(s) traveling on a road; a database that accumulates primary data acquired by the sensor(s); a user-specific processing content storage part that stores a user-specific processing content(s) defining a processing content(s) on the primary data for each data user; a data processing part that reads out the user-specific processing content(s) stored in the user-specific processing content storage part and creates secondary data for the data user(s) from the primary data; and a data transmission part that transmits the secondary data to the data user(s).

According to a second aspect, there is provided an information provision method, wherein a computer including a data acquisition part that acquires data from a sensor(s) installed to grasp movement of a vehicle(s) traveling on a road and a database that accumulates primary data acquired by the sensor(s); reads out a user-specific processing content(s) that defines a processing content(s) on the primary data and that is stored in a user-specific processing content storage part for each data user and creates secondary data for the data user(s) from the primary data; and transmits the secondary data to the data user(s). This method is associated with a certain machine referred to as the computer including the data acquisition part and the database as described above.

According to a third aspect, there is provided a computer program (hereinafter, a program) for realizing the function of the above information provision apparatus. This program is inputted to a computer apparatus via an input device or a communication interface from the outside, is stored in a storage device, and causes a processor to drive in accordance with predetermined steps or processing. In addition, the program can display, as needed, a processing result including an intermediate state per stage on a display device or can communicate with the outside via a communication interface. For example, the computer apparatus for this purpose typically includes a processor, a storage device, an input device, a communication interface, and as needed, a display device, which can be connected to each other via a bus. In addition, this program can be a recorded in a computer-readable (non-transitory) storage medium.

### Advantageous Effects of Invention

According to the present invention, it is possible to effectively utilize information obtained by various sensors installed on a road or the like.

### BRIEF DESCRIPTION OF DRAWINGS

FIG. 1 is a diagram illustrating a configuration according to an example embodiment of the present invention.

FIG. 2 is a diagram illustrating a configuration of an information provision apparatus according to a first example embodiment of the present invention.

FIG. 3 is a diagram illustrating an example of data accumulated in a database in the information provision apparatus according to the first example embodiment of the present invention.

FIG. 4 is a diagram illustrating an example of customer-specific processing contents set in the information provision apparatus according to the first example embodiment of the present invention.

FIG. 5 is a flowchart illustrating an operation of the information provision apparatus according to the first example embodiment of the present invention.

FIG. 6 is a diagram illustrating a configuration of an information provision apparatus according to a second example embodiment of the present invention.

FIG. 7 is a diagram illustrating an example of customer-specific processing contents set in the information provision apparatus according to the second example embodiment of the present invention.

FIG. 8 is a diagram illustrating a configuration of an information provision apparatus according to a third example embodiment of the present invention.

FIG. 9 is a diagram illustrating an example of customer-specific processing contents set in the information provision apparatus according to the third example embodiment of the present invention.

FIG. 10 is a diagram illustrating a configuration of an information provision apparatus according to a fourth example embodiment of the present invention.

FIG. 11 is a diagram illustrating a configuration of a computer making up the information provision apparatus according to the present invention.

### EXAMPLE EMBODIMENTS

First, an outline of an example embodiment of the present invention will be described with reference to a drawing. Note, in the following outline, reference signs of the drawing are denoted to each element as an example for the sake of convenience to facilitate understanding and description of this outline is not intended to limit the present invention to the illustrated modes. An individual connection line between blocks in the drawings, etc. referred to in the following description includes both one-way and two-way directions. A one-way arrow schematically illustrates a principal signal (data) flow and does not exclude bidirectionality. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner. In addition, while a port or an interface is present at an input/output connection point of an individual block in the relevant drawings, illustration of the port or the interface is omitted. In addition, in the following description, “A and/or B” signifies A or B or A and B.

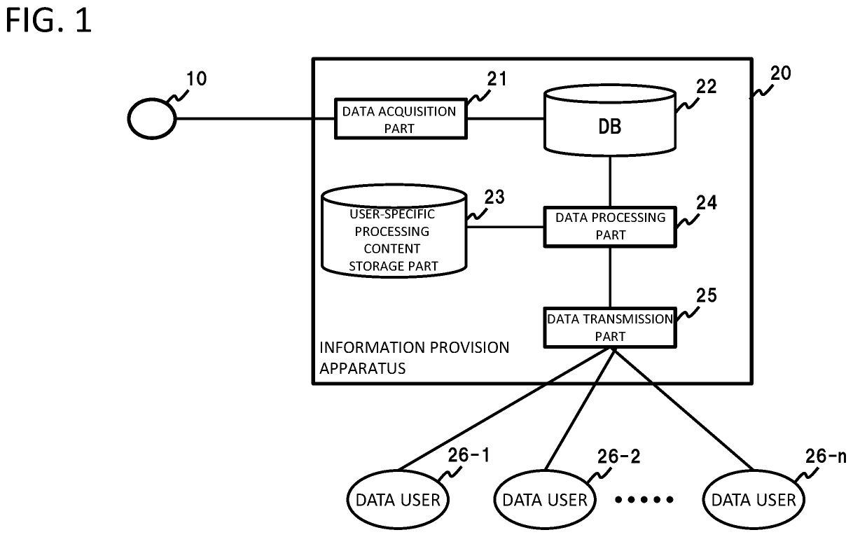

The present invention, in one example embodiment, can be realized by an information provision apparatus 20 including, as illustrated in FIG. 1, a data acquisition part 21, a database (DB) 22, a user-specific processing content storage part 23, a data processing part 24, and a data transmission part 25. The data transmission part 25 is configured to be able to communicate with data users 26-1, 26-2, . . . , and 26-n.

More concretely, the data acquisition part 21 acquires data from a sensor(s) installed to grasp movement of a vehicle(s) traveling on a road and accumulates the data in the database (DB) 22.

The user-specific processing content storage part 23 stores a user-specific processing content(s) defining a processing content(s) on the primary data for each data user. The data processing part 24 reads out the user-specific processing content(s) stored in the user-specific processing content storage part 23 and creates secondary data for the data user(s) from the primary data.

The data transmission part 25 transmits the secondary data to the data user(s).

According to the information provision apparatus 20 as described above, it is possible to effectively utilize information obtained by various sensors installed on a road or the like. This is because a configuration is employed, in which, by using the data acquired from the sensor(s) installed to grasp the movement of vehicle(s) traveling on the road, the secondary data for the data user(s) is created and transmitted.

### First Example Embodiment

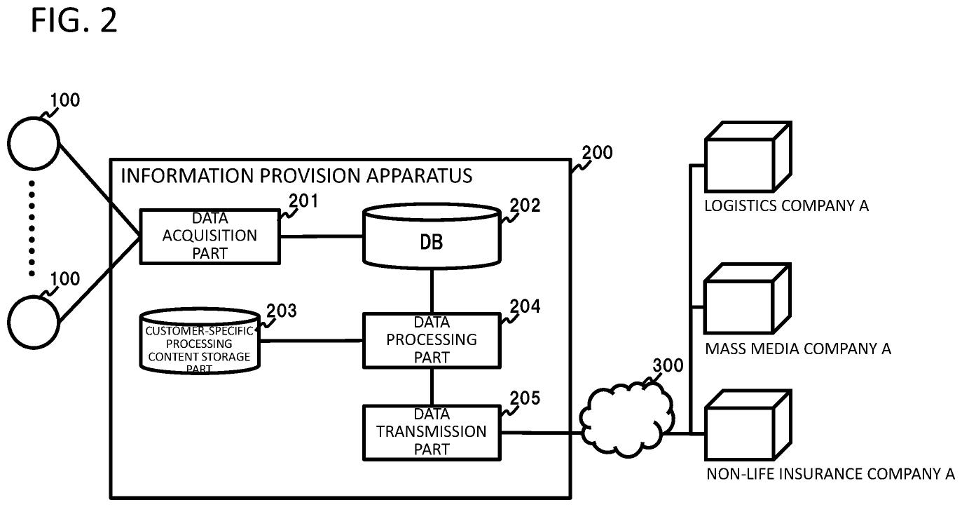

Next, a first example embodiment of the present invention will be described in detail with reference to drawings. FIG. 2 is a diagram illustrating a configuration of an information provision apparatus according to the first example embodiment of the present invention. With reference to FIG. 2, an information provision apparatus 200 connected to a plurality of sensors 100 is illustrated. Furthermore, the information provision apparatus 200 is configured to be able to provide secondary data, which is obtained by processing data acquired from the sensors 100, to a logistics company A, a mass media company A, and a non-life insurance company A, which are data users, via a network 300.

The information provision apparatus 200 includes a data acquisition part 201, a database (DB) 202, a customer-specific processing content storage part 203, a data processing part 204, and a data transmission part 205.

The present example embodiment will be described assuming that the sensors 100 are traffic volume measuring devices installed on a road side or at a plurality of locations. Of course, sensors other than the traffic volume measuring devices may be disposed as the sensors 100.

The data acquisition part 201 acquires data from the sensors 100 and accumulates the data in the database (DB) 202.

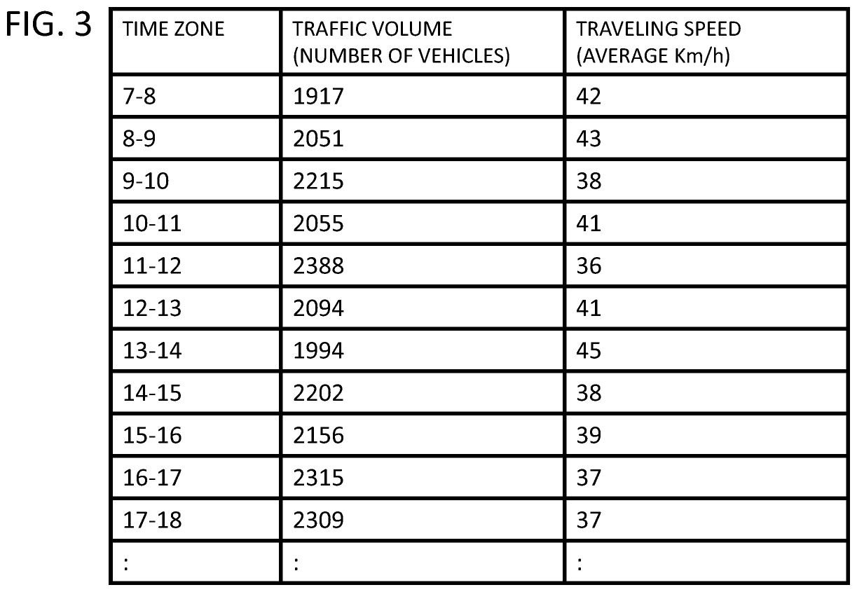

FIG. 3 is a diagram illustrating an example of data accumulated in the database in the information provision apparatus according to the present example embodiment. The example in FIG. 3 illustrates traffic volume data measured by the sensor(s) 100 at a certain intersection per time zone. The example in FIG. 3 indicates that 1,917 vehicles passed through this intersection between 7 and 8 o'clock were observed and that the average speed was 42 km/h. Such data itself is equivalent to that measured by the police or a local government.

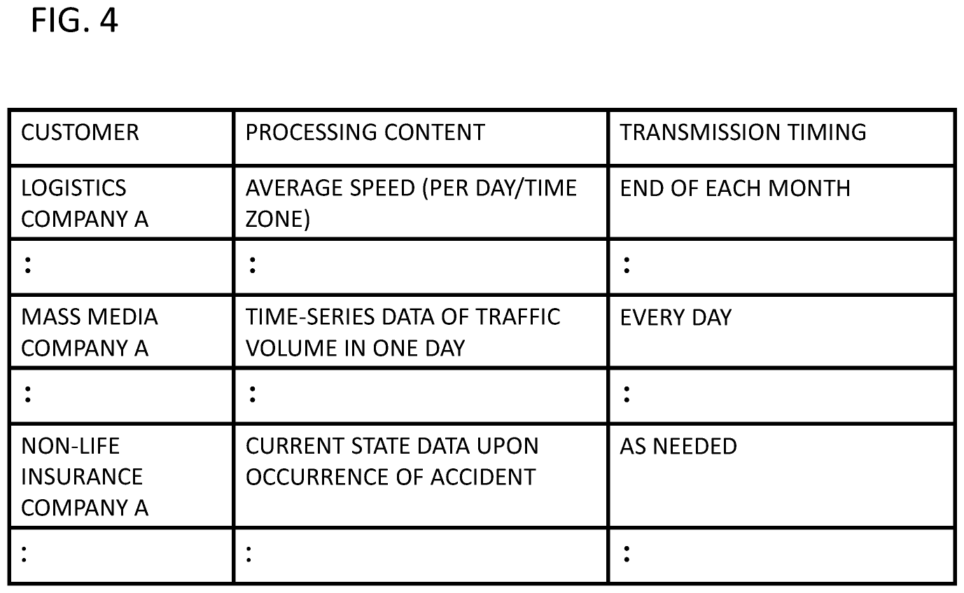

The customer-specific processing content storage part 203 stores a user-specific processing content(s) defining a processing content(s) on primary data per customer who is a data user. FIG. 4 is a diagram illustrating an example of the customer-specific processing contents set in the information provision apparatus according to the present example embodiment. In the example in FIG. 4, processing contents are set for three companies, which are the logistics company A, the mass media company A, and the non-life insurance company A, as customers.

The processing content set for the logistics company A is an average speed per day/per time zone at a location where a sensor 100 is installed. Furthermore, the end of each month is set as the transmission timing of the average speed. The logistics company A can review the delivery route at a predetermined timing every month by using the average speed per day/per time zone at the location where the sensor 100 is installed.

The processing content set for the mass media company A is time-series data of a traffic volume in a day at a location where a sensor 100 is installed. Furthermore, “every day” is set as the transmission timing of the time-series data. The mass media company A can create news for reporting fixed-point observation values of the traffic volume by using the time-series data of the traffic volume in a day. These fixed-point observation values of the traffic volume can be used as an index for clearly reporting whether or not the movement of people has actually reduced in a situation where restrictions or voluntary restraints on outings are imposed due to an epidemic of infectious disease or the like.

The processing content set for the non-life insurance company A is current state data at the time of occurrence of an accident in a place where a sensor 100 is installed. Furthermore, “as needed” is set as the transmission timing of the current state data such that the data is transmitted upon occurrence of an accident. The non-life insurance company A can facilitate the investigation of a traffic accident by using the current state data obtained upon occurrence of the accident.

The customer-specific processing contents described above are merely examples and are not limited to the above examples. For example, the logistics company A may request a different processing content at the location where the sensor 100 is installed. In addition, the business types of the customers are not limited to those exemplified in Fig. and customers of other business types may be also included. Furthermore, a plurality of customers of the same business type and their respective processing contents may also be registered.

The data processing part 204 reads out the customer-specific processing contents stored in the customer-specific processing content storage part 203 and creates secondary data for the customers from the data (primary data) accumulated in the DB 202.

The data transmission part 205 transmits the secondary data to the customers in accordance with the transmission timings in their respective customer-specific processing contents stored in the customer-specific processing content storage part 203.

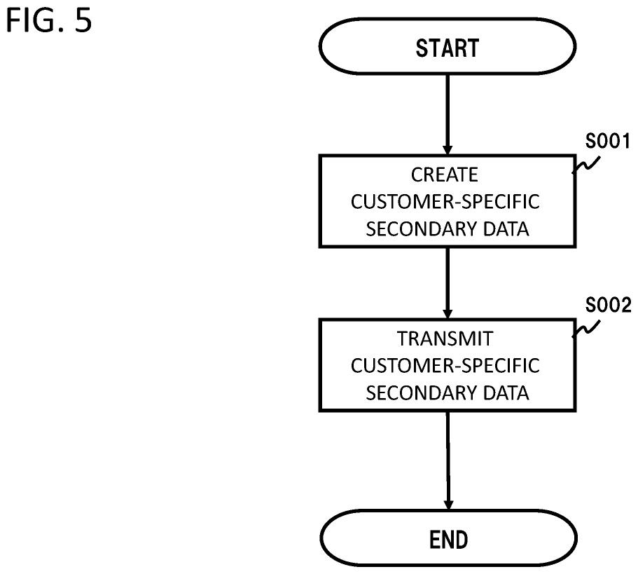

Next, an operation of the present example embodiment will be described in detail with reference to drawings. FIG. 5 is a flowchart illustrating an operation of the information provision apparatus 200 according to the first example embodiment of the present information. With reference to FIG. 5, first, the information provision apparatus 200 operates at a predetermined period and creates customer-specific secondary data (step S001). Note, a fixed period shorter than a data storage period in the DB 202 is set as the predetermined period (the timing at which the secondary data is created). For example, when the data storage period in the DB 202 is 72 hours, if the predetermined period is set to 72 hours or more, necessary data cannot be obtained. In this case, the predetermined period needs to be set less than 72 hours. In addition, the predetermined period may be a period shorter than a period set for a processing content. For example, because the secondary data for the mass media company A in FIG. 4 needs to be transmitted every day, the secondary data cannot be created every day if the predetermined period is set to 72 hours. In this case, the cycle of processing the secondary data for the mass media company A in FIG. 4 needs to be set less than 24 hours.

While the timing at which the secondary data is created is not explicitly indicated in the example in FIG. 4, the timing at which the secondary data is created may be explicitly set as a customer-specific processing content. For example, in the case of the average speed per day/per time zone set for the logistics company A in FIG. 4, the primary data accumulated in the DB 202 is read out at a predetermined time every day to calculate the average speed per time zone.

In addition, depending on the customer, as is the case with the non-life insurance company A in FIG. 4, it may be set that the secondary data is created and transmitted upon occurrence of an event, not at a fixed timing. In this case, the information provision apparatus 200 performs processing of step S001 at a timing of occurrence of an event defined in the corresponding processing content.

Next, the information provision apparatus 200 transmits the secondary data created in step S001 to the customer (step S002). Note, the information provision apparatus 200 may employ a configuration in which after accumulating secondary data for a certain period of time and then transmit the secondary data to the customer, instead of transmitting the secondary data each time the secondary data is created. For example, since the transmission timing of the secondary data for the logistics company A in FIG. 4 is once a month, the information provision apparatus 200 accumulates the secondary data for one month and then transmits the secondary data for the logistics company A.

As described above, according to the present example embodiment, it is possible to create secondary data (statistical information obtained by using measured traffic volume values), of which the added value has been further increased by additionally performing customer-specific processing on primary data, and to provide the created secondary data to the customer. Further, the present example embodiment is effective even when the storage period of the primary data is short, and secondary data on which desired processing has been performed can be reliably created. This is because, a configuration in which the primary data first is accumulated in the DB 202, and the secondary data is next created at a predetermined period shorter than the data storage period in the DB 202 is employed.

### Second Example Embodiment

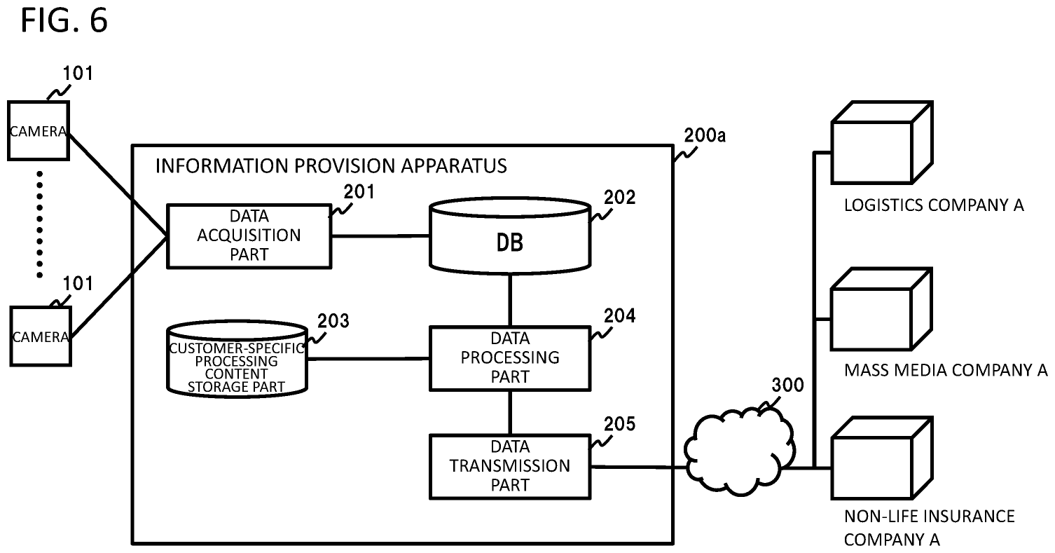

Next, a second example embodiment of the present invention will be described in detail with reference to drawings. In the second example embodiment, cameras are used as sensors 100 so that more valuable secondary data can be provided. FIG. 6 is a diagram illustrating a configuration of an information provision apparatus according to the second example embodiment of the present invention. This configuration differs from that according to the first example embodiment illustrated in FIG. 2 in that the sensors 100 are replaced by cameras 101 and that a processing content(s) using image data captured by the cameras is set in a customer-specific processing content storage part 203. The rest of the configuration is the same as that according to the first example embodiment, and the following description will be made with a focus on the difference.

The camera 101 is a camera installed at an intersection or a road side as a sensor installed to grasp the movement of vehicles traveling on a road. In the present example embodiment, sensors other than the cameras 101 may be disposed. For example, data may be acquired from a Light Detection and Ranging (LiDAR), a millimeter wave sensor, or the like.

A data acquisition part 201 acquires image data from the cameras 101 and accumulates the acquired image data in a database (DB) 202.

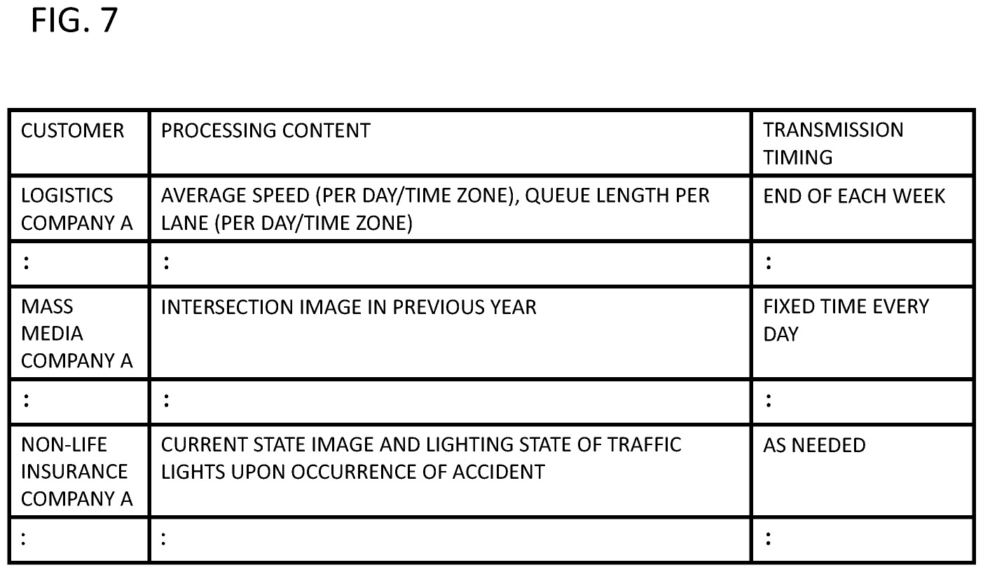

FIG. 7 is a diagram illustrating an example of the customer-specific processing contents set in the customer-specific processing content storage part 203 in the information provision apparatus according to the present example embodiment. In the example in FIG. 7, processing contents are set for three companies, which are a logistics company A, a mass media company A, and a non-life insurance company A, as customers.

The processing content set for the logistics company A is an average speed per day/per time zone and a queue length in an individual lane per day/per time zone at a place where a camera 101 is installed. Furthermore, the end of each week is set as the transmission timing of the obtained data. The logistics company A can review a delivery route at a predetermined timing every week by using the average speed and the queue length in the individual lane per day/per time zone at the place where the camera 101 is installed. Note, the queue length in the individual lane indicates a queue length (the number of vehicles in a traffic jam) per lane, such as a left-turn lane, a straight lane, and a right-turn lane, at an intersection. Such a queue length per lane can be calculated from the average or maximum value or the like of the number of vehicles stuck in a traffic jam per lane in an image obtained by the camera.

The processing content set for the mass media company A is image data obtained on the same day as that in the previous year obtained at an intersection where a camera 101 is installed. Furthermore, “every day” is set as the transmission timing of the obtained data. The mass media company A can create news for reporting change in traffic volume from the last year by using the image data obtained on the same day as that in the previous year at the intersection. The image obtained on the same day as that in the previous year at the intersection can visually show whether or not the movement of people has actually reduced in a situation where restrictions or voluntary restraints on outings are imposed due to an epidemic of infectious disease or the like.

The processing content set for the non-life insurance company A is current state image data and a lighting state of traffic lights at the time of occurrence of an accident at a place where a sensor 100 is installed. Furthermore, “as needed” is set as the transmission timing such that the data is transmitted upon occurrence of an accident. The non-life insurance company A can facilitate the investigation of a traffic accident by using the current state image data and the lighting state of traffic lights upon occurrence of the accident. In particular, the lighting state of the traffic lights at the time of occurrence of an accident can be used for calculating a percentage of negligence in the traffic accident.

As described above, the present invention is suitably applicable to a mode in which a camera is used as a sensor. It is also preferable to add a function of identifying a vehicle type and model from an image of a vehicle captured in an image to a data processing part 204. In this way, the data processing part 204 can perform statistical processing or the like per vehicle type or model. For example, the average speed and the accident occurrence rate per vehicle type or model can be used as reference materials when the non-life insurance company A reviews the insurance premium per vehicle model. Likewise, it is possible to add a function of identifying, from an image of the inside of a vehicle captured in an image, the number of passengers in the vehicle and the age (age group) and gender of the driver of the vehicle to the data processing part 204. The average speed and the accident occurrence rate per driver age (age group) can be used as reference materials when the non-life insurance company A reviews the insurance premiums of the insured persons per age group.

### Third Example Embodiment

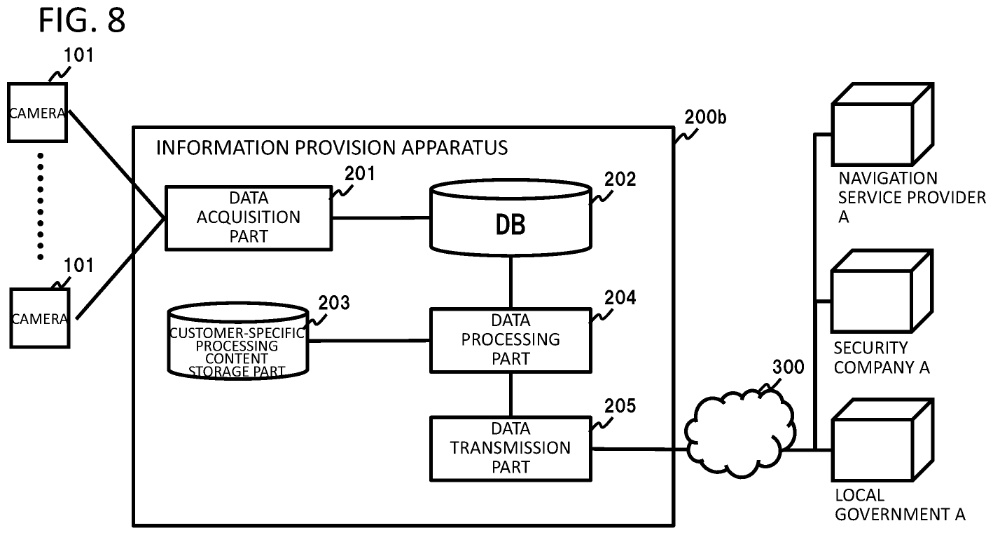

In the above first and second example embodiments, the processing contents have been described in a case where the customers are the logistics company, the mass media company, and the non-life insurance company. However, companies and the like that can receive the benefit of the present invention are not limited to these examples. Next, a third example embodiment of the present invention will be described in detail with reference to drawings, assuming that the customers are a navigation service provider A, a security company A, and a local government (public organization) A. FIG. 8 is a diagram illustrating a configuration of an information provision apparatus according to the third example embodiment of the present invention. This configuration differs from that according to the second example embodiment illustrated in FIG. 6 in that the logistics company A, the mass media company A, and the non-life insurance company A illustrated on the right side of FIG. 6 are replaced by the navigation service provider A, the security company A, and the local government A. The rest of the configuration is the same as that according to the second example embodiment, and the following description will be made with a focus on the difference.

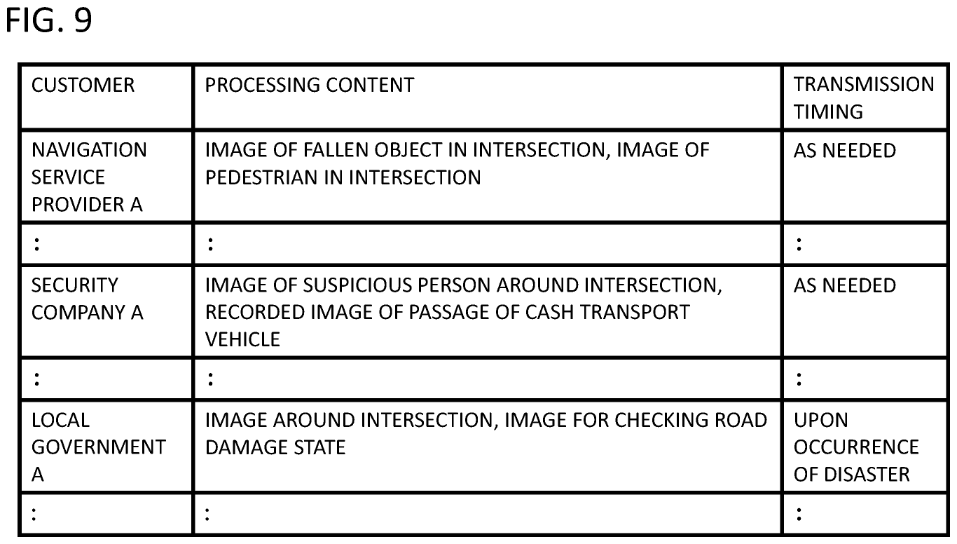

FIG. 9 is a diagram illustrating an example of the customer-specific processing contents set in a customer-specific processing content storage part 203 in the information provision apparatus according to the present example embodiment. In the example in FIG. 9, as described above, processing contents are set for three entities, which are the navigation service provider A, the security company A, and the local government A, as customers.

The processing content set for the navigation service provider A is extraction of an image of a fallen object at an intersection where a camera 101 is installed and extraction of an image of a pedestrian in the intersection. Furthermore, “as needed” is set as the transmission timing thereof such that transmission is performed when a fallen object or a pedestrian is detected. By using the image of the fallen object at the intersection where the camera 101 is installed and the image of the pedestrian in the intersection, the navigation service provider A can distribute information about the fallen object and the pedestrian to its own service users. Because there are cases in which such fallen objects and pedestrians are not captured by a dynamic map or a driving safety support system (DSSS), the navigation service provider A can differentiate itself from the other navigation service providers.

The processing content set for the security company A is extraction of an image of a suspicious person around an intersection where a camera 101 is installed and extraction of a recorded image of passage of its cash transport vehicle. Furthermore, “as needed” is set as the transmission timing thereof such that transmission is performed when passage of a suspicious person or a cash transport vehicle is detected. The security company A can call for attention to its own service users by using the image of the suspicious person around the intersection. In addition, the security company A can manage the operation of its own cash transport vehicle by using the recorded image of passage of its own cash transport vehicle.

The processing content set for the local government A is extraction of an image around an intersection where a camera 101 is installed and extraction of an image for checking a state of road damage. Furthermore, “upon occurrence of disaster” is set as the transmission timing thereof. Upon occurrence of a disaster, the local government A can grasp the damage state by using the image around the intersection and the image for checking the road damage state. The local government A can also guide affected residents and vehicles to an evacuation site by using these images.

As described above, the customers to whom the information is to be provided are not limited to a logistics company, a mass media company, and a non-life insurance company. That is, other companies and organizations are also assumed as customers. Further, various processing contents can be set, depending on the business of each customer. In this way, more advanced services using the primary data can be provided.

### Fourth Example Embodiment

In the above first to third example embodiments, the data processing part 204 creates secondary data for the individual customers from the data (primary data) accumulated in the DB 202. However, there are cases in which customers request their respective secondary data obtained by using data obtained through a period longer than the data storage period at the DB 202. In this case, it is desirable that the information provision apparatus be provided with, per user, a user-specific data storage part that stores the secondary data or intermediate data for creating the secondary data. Hereinafter, a fourth example embodiment will be described, in which a customer-specific data storage part is added to an information provision apparatus as a user-specific data storage part.

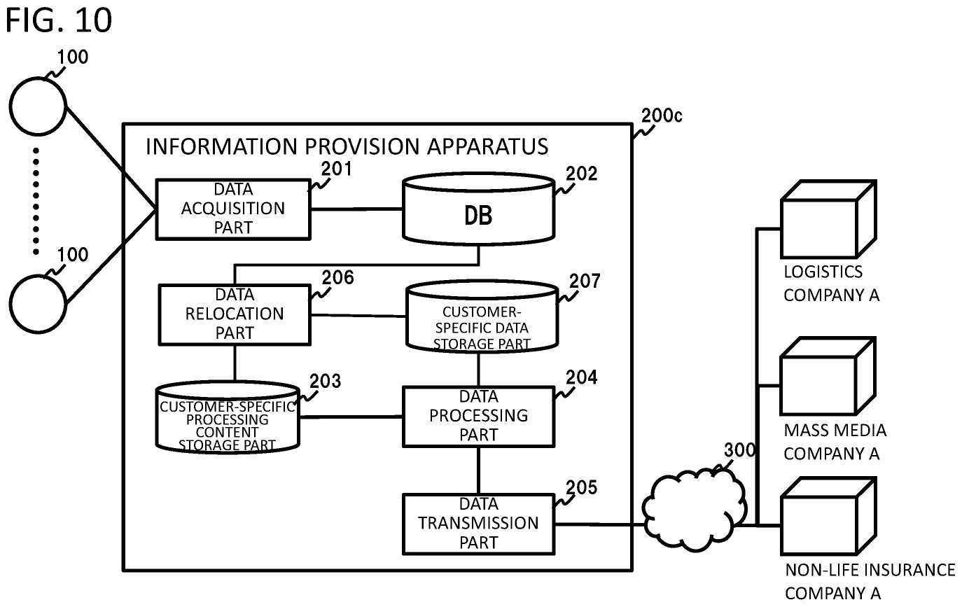

FIG. 10 is a diagram illustrating a configuration of an information provision apparatus according to the fourth example embodiment of the present invention. This configuration differs from that according to the first example embodiment illustrated in FIG. 2 in that a data relocation part 206 and a customer-specific data storage part 207 is added to the information provision apparatus 200c. The rest of the configuration is the same as that according to the first example embodiment, and the following description will be made with a focus on the difference.

The data relocation part 206 extracts data from a DB 202 at a predetermined period and stores the extracted data in the customer-specific data storage part 207.

The customer-specific data storage part 207 stores the data extracted from the DB 202 for a storage period previously determined with a corresponding customer. In addition to the storage of the data extracted from the DB 202, the customer-specific data storage part 207 may be used as a storage destination of intermediate data that has been processed by the data processing part 204.

According to the above fourth example embodiment, tit becomes possible to store data for an extremely long period of time and process the data in accordance with the needs of the customer. For example, if the mass media company A needs traffic volume time-series data obtained on a specific day 10 years ago, by storing the data in the customer-specific data storage part 207, such needs can be met. In addition, by storing the intermediate data in the customer-specific data storage part 207, the calculation cost of the data processing part 204 can be reduced. For example, in a case where the average speed (per day/time zone) per month in the last one year is provided, the calculation of the data processing part 204 can be reduced by one month by storing the calculation result of the previous month.

While example embodiments of the present invention have thus been described, the present invention is not limited thereto. Further variations, substitutions, or adjustments can be made without departing from the basic technical concept of the present invention. For example, the configurations of the networks and elements and the representation modes of the data illustrated in the drawings have been used only as examples to facilitate understanding of the present invention. That is, the present invention is not limited to the configurations illustrated in the drawings.

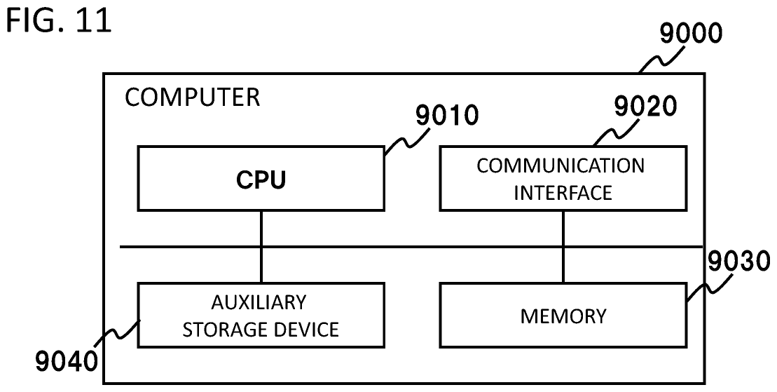

Each of the procedures described in the above first to fourth example embodiments can be realized by a program that causes a computer (9000 in FIG. 11) which functions as the information provision apparatus 200 to realize the function as the information provision apparatus 200. This computer includes, for example, a CPU (Central Processing Unit) 9010, a communication interface 9020, a memory 9030, and an auxiliary storage device 9040 in FIG. 11. That is, the CPU 9010 in FIG. 11 performs the data processing program and the data transmission program and performs processing for updating various calculation parameters stored in the auxiliary storage device 9040, etc.

That is, the individual parts (processing means, functions) of the information provision apparatus 200 according to the above first to fourth example embodiments can be realized by a computer program that causes a processor mounted on the information provision apparatus 200, by using its hardware, execute each processing as described above.

Finally, suitable modes of the present invention will be summarized.

### [Mode 1]

(See the information provision apparatus according to the above first aspect)

### [Mode 2]

The user-specific processing content(s) in the information provision apparatus may include at least a timing at which the created secondary data is transmitted.

### [Mode 3]

The user-specific processing content(s) may further include a timing at which the secondary data is created.

### [Mode 4]

It is possible to employ a configuration in that the information provision apparatus may further include a user-specific data storage part that stores the secondary data or intermediate data for creating the secondary data for each user, and the data processing part may create the secondary data or the intermediate data by using the user-specific data storage part before the primary data is deleted from the database.

### [Mode 5]

The sensor(s) may be a camera(s) disposed on a road side or at an intersection. In this case, the user-specific processing content storage part may store a processing content for creating a traffic accident report by using an image(s) captured by the camera(s) for a predetermined data user.

### [Mode 6]

The sensor(s) may be a traffic volume measuring device(s) disposed on a road side or at an intersection. In this case, the user-specific processing content storage part may store a processing content for creating statistical information by using measured values of traffic volume recorded by the traffic volume measuring device(s) for a predetermined data user.

### [Mode 7]

(See the information provision method according to the above second aspect)

### [Mode 8]

(See the program according to the above third aspect)

### [Mode 9]

(See the computer-readable recording medium storing the program described in Mode 8)

Note, the above modes 7 to 9 can be expanded in the same way as mode 1 is expanded to modes 2 to 6.

The disclosure of each of the above PTLs is incorporated herein by reference thereto and may be used as the basis or a part of the present invention, as needed. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. AS to numerical value ranges disclosed in the description, even if the description does not particularly disclose arbitrary numerical values or small ranges included in the ranges, these values and ranges should be deemed to have been concretely disclosed. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

20, 200, 200a, 200b, 200c information provision apparatus
21, 201 data acquisition part
22, 202 database (DB)
23 user-specific processing content storage part
24, 204 data processing part
25, 205 data transmission part
100 sensor
101 camera
206 data relocation part
207 customer-specific data storage part
300 network
9000 computer
9010 CPU
9020 communication interface
9030 memory
9040 auxiliary storage device

What is claimed is:

1. An information provision apparatus, comprising:
at least a processor; and
a memory in circuit communication with the processor,
wherein the processor is configured to execute program instructions stored in the memory to:
acquire data from a sensor(s) installed to grasp movement of a vehicle(s) traveling on a road;
read out the user-specific processing content(s) defining a processing content(s) on primary data acquired by the sensor(s) accumulated in a database, for each data user, stored in a user-specific processing content storage and create secondary data for the data user(s) from the primary data; and
transmit the secondary data to the data user(s).

2. The information provision apparatus according to claim 1, wherein the user-specific processing content(s) includes at least a timing at which the created secondary data is transmitted.

3. The information provision apparatus according to claim 2, wherein the user-specific processing content(s) further includes a timing at which the secondary data is created.

4. The information provision apparatus according to claim 1,
wherein the processor creates the secondary data or the intermediate data by using a user-specific data storage which stores the secondary data or intermediate data for creating the secondary data for each user before the primary data is deleted from the database.

5. The information provision apparatus according to claim 1,
wherein the sensor(s) is a camera(s) disposed on a road side or at an intersection, and
wherein the user-specific processing content storage part stores a processing content for creating a traffic accident report by using an image(s) captured by the camera(s) for a predetermined data user.

6. The information provision apparatus according to claim 1,
wherein the sensor(s) is a traffic volume measuring device(s) disposed on a road side or at an intersection, and
wherein the user-specific processing content storage stores a processing content for creating statistical information by using measured values of traffic volume recorded by the traffic volume measuring device(s) for a predetermined data user.

7. An information provision method, wherein
a computer;
acquires data from a sensor(s) installed to grasp movement of a vehicle(s) traveling on a road;
reads out a user-specific processing content(s) that defines a processing content(s) on the primary data acquired by the sensor(s) accumulated in a database stored in a user-specific processing content storage for each data user and creates secondary data for the data user(s) from the primary data; and
transmits the secondary data to the data user(s).

8. A computer-readable non-transient recording medium recording a program, the program causing a computer to perform processings of:
acquiring data from a sensor(s) installed to grasp movement of a vehicle(s) traveling on a road;
reading out a user-specific processing content(s) that defines a processing content(s) on the primary data and that is stored in a user-specific processing content storage per data user and creating secondary data for the data user(s) from the primary data; and
transmitting the secondary data to the data user(s).

9. (canceled)

10. The information provision method according to claim 7, wherein the user-specific processing content(s) includes at least a timing at which the created secondary data is transmitted.

11. The information provision method according to claim 10, wherein the user-specific processing content(s) further includes a timing at which the secondary data is created.

12. The information provision method according to claim 7,
wherein the computer further creates the secondary data or the intermediate data by using a user-specific data storage that stores the secondary data or intermediate data for creating the secondary data for each user before the primary data is deleted from the database.

13. The information provision method according to claim 7,
wherein the sensor(s) is a camera(s) disposed on a road side or at an intersection, and
wherein the user-specific processing content storage stores a processing content for creating a traffic accident report by using an image(s) captured by the camera(s) for a predetermined data user.

14. The information provision method according to claim 7,
wherein the sensor(s) is a traffic volume measuring device(s) disposed on a road side or at an intersection, and
wherein the user-specific processing content storage stores a processing content for creating statistical information by using measured values of traffic volume recorded by the traffic volume measuring device(s) for a predetermined data user.

15. The medium according to claim 8, wherein the user-specific processing content(s) includes at least a timing at which the created secondary data is transmitted.

16. The medium according to claim 15, wherein the user-specific processing content(s) further includes a timing at which the secondary data is created.

17. The medium according to claim 8,
wherein the program further causes the computer to perform processing of creating the secondary data or the intermediate data by using a user-specific data storage that stores the secondary data or intermediate data for creating the secondary data for each user before the primary data is deleted from the database.

18. The medium according to claim 8,
wherein the sensor(s) is a camera(s) disposed on a road side or at an intersection, and
wherein the user-specific processing content storage stores a processing content for creating a traffic accident report by using an image(s) captured by the camera(s) for a predetermined data user.

19. The medium according to claim 8,
wherein the sensor(s) is a traffic volume measuring device(s) disposed on a road side or at an intersection, and
wherein the user-specific processing content storage stores a processing content for creating statistical information by using measured values of traffic volume recorded by the traffic volume measuring device(s) for a predetermined data user.
